(19) United States
(12) Patent Application Publication
(10) Pub. No.: US 2023/0244978 A1
(43) Pub. Date: Aug. 3, 2023

(54) Congruent Quantum Computation Theory (CQCT)

(71) Applicant: The Young Java Holdings Company, Huntington Beach, CA (US)

(72) Inventor: DARRECK LAMAR BENDER, II, Huntington Beach, CA (US)

(21) Appl. No.: 17/592,345

(22) Filed: Feb. 3, 2022

(51) Int. Cl. G06N 10/60

(52) U.S. Cl. CPC G06N 10/60

(57) ABSTRACT

This disclosure relates generally to application of physics, biological principles, computational engineering practices to enrich data science theory and serve as an architectural reference point for the way data is organized for an artificial intelligence or machine learning based segment or personalization instance. Structuring datasets in this specific format will increase data continuity and the efficacy of the correlated computational classes at the micro and macro level. A data classification and computation concept which will be applied across various disciplines and domains public and private and utilized as the basis of all relative scientific practices and theory for the 21 century and beyond.

An algorithmic process which combines biological observational and their associated computations, physics dimensional classes, functions, and the associated property definitions; to create an error-free, lossless method for quantum computational engineering in the 21st century and beyond. An algorithmic process that classifies data types by its function as observed by the system and correlates the specified values with its congruent algorithmic computational class to define the-computational weight of the value at macro computational level and interdimensional relativity to other values. A process to formalize data in a way to decompute sociocultural and economic biases through congruent macro/micro algorithmic computation, observations and classifications, and the aggregate thereof at scale.

A data architecture method that uses prefixed integers for each classification observed at the macro computational level by calibrating the micro data values to a measurable absolute zero. A computational engineering practice that observes various data types, functions and volumes of energy produced by a numeric value. A computational engineering practice in which 2-dimensional datasets can be recalibrated and applied with proper context algorithmically, and 3-dimensional can be utilized ethically with efficacy. A computational engineering practice that serves as the baseline of ethical data application in segmentation and personalization tools and instances. A computational engineering practice that aggregates, observes and measures the potential energy of data as classified by its functional, property and dimensional correlation.

A computational engineering practice that updates data tables and impacted datasets real-time through stacking two or more congruently classified algorithmic computations and several sets of delimiters containing classification criteria, observed properties and activity tables and the measurement of those rulesets against several sets of delimiters containing live classification criteria, activity tables and property tables. As a result of the equation, the data will identify the maximum computing capacity necessary for a specified data set, and define the system capacity required to process the data; thus, enabling the calibration of the computational power a (−1) to south of infinite while delimining absolutes and contextualizing relativity within a specified segment or across multidimensional data structures. The Congruent Quantum Computation Theory will be utilized to create new products, services and experiences. The CQCT will also be utilized to find data insights and serve as the structural bases of conducting culturally inclusive R&D for various disciplines and domains, public and private in the 21st century and beyond.

### BACKGROUND OF INVENTION

Innovation is the act of introducing new ideas, devices or methods to improve existing products or services. While innovation is always welcomed, new is not always necessary and as Albert Einstein would say the basis of most things can be “relative”. Innovation, if applied in the context of now, as it relates to mathematical sciences, all core computations of product and service markets, function on a two-dimensional plane and are expressed in a three dimensional reality. The root of this is the quality of infrastructure built during the early industrialism age, which was phenomenal, and at the time supported our interest to create an infrastructure where none existed. The necessity to innovate at an exponential rate, based on the quality of the innovations that served as societal infrastructures, was extremely high, and due to the disparity in information distribution there was not an opportunity to create the upward mobility necessary to sustain the infrastructure and the U.S. economy, thus the necessity for globalization.

From the context of globalization being the catalyst for what we perceive as our perceptual reality, the separation of information as it relates to production cost and the product market value, creating a dichotomy of separate but equal realities in our perception of our dimensional position. For example, a production company that creates a product, but is separated from the customer market and the transaction, but still sells to the company that does, transacts it in a 2-D reality. The customer that makes a product purchase from a retail brand, and does not know where to source the product, then the customer is transacting in a 2-D reality. However, the brand that was created from an end-to-end supply chain, linking the customer to a product, sourced and acquired by the brand, functions at a multidimensional level. The separation of information within this transaction line has decreased significantly due to the access to information one the internet. This is the core concept of why it is time to innovate now, and make some optimizations to the crux of our infrastructure across the United States.

Now we know that every new idea, as it relates to the products and services industry, has to be measured against several contextual matrices to understand the measurement of success and efficacy for any product in today's market. This stands true to the concept of hiring a vendor or purchasing a boxed solution at the enterprise level. No matter how well the tool boasts of working, inevitably measurement is the ultimate shot caller. The questions most relative to your organizations will be: How has this product performed against the cost, time it took to integrate, scope of service layer enablement, impacts to systems of records, measurement of customer satisfaction/dissatisfaction, line of communication and resolution. Innovation can be measured in a way that it can be argued it has kept up with its own path in concept and application alike, while maintaining an open door to new realities if so you may choose.

Currently in the workforce across various domains the speed in which innovation is necessary has accelerated since the last innovation age. We have gained our own ways to communicate survival codes at the microcultral level to maintain enough upward mobility to keep up with our perception of the 2-D reality. We communicate with each other through brevity, metaphoric statements that by way of relativity evolve the way that we think and live. With this context, we have the building blocks to scope for the infrastructural changes we need based on the use cases reflected by an updated division of labor model. This is only one piece but, has been one of the most challenging aspects to reaching the data congruence necessary to make this happen, but the datasets do indeed exist.

The concept of quantum innovation is the practice of creating something new and measure that against the market attachment probability score assessment divided by our socio-cultural landscape to identify product relativity to the market, and use this as the baseline of innovation so that a holistic scope of capabilities for happy path users, and systems abilities built for low engagement digital segments are deployed in a balanced fashion.

The concept of upward mobility, spoke to how high the ceiling seemed in our new world during the age of industrialism. The concept of “upward agility” is for the businesses that stimulate the product market to assist in equipping the public in truly understanding the quantum reality through new product offerings, services and capabilities on the web and in-store in exchange for retention of their brand in the product market also. The necessity to establish a feedback loop to truly understand how digital experiences are materializing for the public is imperative to market retention. The Red Queen hypothesis is a theory in evolutionary biology proposed in 1973, that species must constantly adapt, evolve, and proliferate in order to survive while pitted against ever-evolving opposing species. In the age of industrialism in America, there was a heavy focus on infrastructure. The ripple effect of this experience was dichotomous, in that if you kept up with the innovation path of your skillset or trade, you had a good chance of maintaining economic stability and reaching relative sustainability. The caveat to that is this dichotomy adapted a “survival of the fittest” model, which in some ways created more socio-cultural gaps than healthy competition. At first glance, this could appear to be an intentional driver of some of the not so pleasant experiences that we have seen today as a result of lack of “access” to information, infrastructure and resources in our country today. But, also there is the responsibility to perceive something new as something old at the time in which it was perceived, thus increasing the ability to attain upward mobility through forward motion.

In the infracture age, there was cultural harmony frankly because everyone needed a job, wanted to build a life and have some form of harmonious living in the neighborhoods they occupied. The affixation during that time to comfort, especially after what was an extremely long stretch of asynchronous laborious servitude. We didn't want to change, and because of that affixation there were major socio-cultural impacts that snowballed and evolved as fast as the path of innovation. Because of this our infrastrally focused society, began to fall into the snowball of societal impacts of innovation rather than proactively solving based off of information we were now privity to. This enamourment to short sightedness can have relative properties and functions of media.

Subsequently, as the volume of these impacts increased, the volume of media coverage regarding the impacts increased and ad revenue began to be generated faster than the time it took to innovate. This is our current conflation of value based off of the 2D/3D asynchronous variance. Within the digital age, the complexity of maintaining one source of truth that can capture various types of data with proper context has proved to be challenging. Additionally as we scale our use of Al/ML to enable segmentation and personalization functions within digital experiences, we must first determine how best to group data based on the vantage in which it was collected. Linear data is a dataset that is collected and computed without proper context of the type of data that has been collected, or the value of each data field. This process is useful when aggregating or logging details such as a patient's treatment history, a user's transaction history, which also could benefit from 1 or 2 layers of context. Hence the necessity for filtering.

For example:

| Name (1) | Age (2) | Gender (3) | Location (4) | Career (5) | Salary (6) | Marital Status (7) |
|---|---|---|---|---|---|---|
| Joe Williamson | 19 | M | Atlanta, GA | Cashier | $24,000 | Single |

Contextual Usage
1. Quantitative Measurement and Reporting

Non-Contextual usage
1. Qualitative Measurement and Reporting (can performed if done at the comparative level)
2. Online Advertising
3. Personalization
4. Establishment of a feedback loop
5. Segmentation
6. Predictive Analysis
7. Artificial Intelligence
8. Machine Learning
9. Relational Data Computation

### SUMMARY

The origins of data or datum carried a quantum context that gathering a feedback loop was the larger purpose of record keeping, and not the records themselves. As we began contextualizing data as transmissible and storable computer information in 1946, the complexity associated with aggregation was more relevant than the analysis of this data at the time, because this task was performed by humans.

In 1954, we began processing data as a linear function measured against time to gather efficiency of a linear factory production output divided by cost. The term big data has been used since the 1990s to quantify the necessity of the management at a storage level of large sets of information over a set period of time. In 2012, the term big data resurfaced and the context was now the diversity and complexity of the data feed at scale. The oversight here was the contextual formalization of the data before computation, thus creating an insights gap in the way datasets are computed and formalized today.

An example of this can be found in the excel spreadsheet model, which utilizes a 2-D classification and 3-D formulas for computation through visualization to express data computed from various properties of the data set. This data table then becomes one of two reference points for the primary key that will link this dataset to another. The basis of data computation today is that a set of information or activities owned or completed by an individual is collected, aggregated and compared amongst the other sets. These dataset can be activities properties, paired with the other data set by relation for the purpose of producing an insight that can be applied internally and externally. This practice captures data with the assumption that all users have the same level of understanding when engaging with the system, therefore having the appearance of being compared at a 1 to 1 level.

### QUANTUM DATA STRUCTURE AND FUNCTIONS

| | | | | Computational |
|---|---|---|---|---|
| Dimension | Quantum Properties | Energy Type | Function | Examples |
| 0 Dimension (A) | n/a | Display | Display | www. (1.0) |
| 1st Dimension (A-B) | n/a | Position | Rank, Sorting | Mapquest |
| 2nd Dimension (A-B-C-D) | quantum categorization is | Momentum | Measurement | Metrics - elapsed time vs. X, |
| | necessary at the 2nd dimension, | | | page loads, session time, drop |
| | which can be measured | | | off, conversion |
| | retroactively at a 0% variance | | | |
| 3rd Dimension (A-B-C-D, | quantum categorization can be | Kinetic | Segmentation, Next | GPS, Satellite |
| A-B-C-D, A-B-C-D) | applied at the 3rd dimension to | | Best Action | |
| | measure activity and produce | | | |
| | experiences retroactively at a | | | |
| | 10%> variance + Potential | | | |
| | Energy Equation | | | |
| 4th Dimension + Beyond | quantum categorization can be | Potential | Schema, A.I. | Growing data schema that is |
| (A-B-C-D, A-B-C-D, | applied at the 4th dimension to | | (undefined) | informed by actions within the |
| A-B-C-D,A-B-C-D) | create a automated growing | | | experience |
| | schema, but will never greatly | | | |
| | influence the structure, all other | | | |
| | dimensions are a reflection of | | | |
| | growing activity within the four | | | |
| | dimension | | | |

### QUANTUM DATA MEASUREMENT SEQUENCE STRUCTURE

subatomic>atomic>observed energy>dimension definition>interdimensional activity>relativity definition>observational measurement

BLOCKCHAIN NODE COMPUTATION DATA TABLE

| | | Data | |
|---|---|---|---|
| Node Type | Dimensional Placement | Function | Experience Examples |
| LightWeight | 0 - Display, 2-D Backend | High Level, | Reports, HL dashboard visualizations |
| | | Refreshable, | |
| | | Archivable | |
| Full | 0 - Display, 1-D Backend | Data Dump | Raw data |
| Pruned | 2-D display, 3D backend | Filtered Data Set | Active or Archived reference files that enable experiences or |
| | | | are inactive but serve as reference point for experience |
| | | | strategy and relative to enterprise data set, serves as context |
| | | | rather content |
| Archival | 2-D Display, 2-D Backend | Reference Files | Relevant for context but no longer user to provide insight for |
| | | | content, still can be leveraged to make relationships |
| Master | 0 - Display, | Independent, but | In the banking industry the master record could contain |
| | 4-D | Active Source of | consumer funds, POS would serve as a middle layer to |
| | | Truth | transact node that is carrying the purchase details to |
| | | | measure against to master record to either accept or decline |
| | | | the transaction |
| | | | Quantum Banking Powered by Blockchain* |
| Mining | 3-D Display, 4D Backend | Provide Data | As per use cases defined by the Experience Designer, Mining |
| | | Insight | nodes will search blockchain for relativity through the |
| | | | defined measurement and present options to link the nodes |
| | | | that are relative to one another, to create a new segment as |
| | | | defined by user activities |
| Staking | 3-D Display, 4D Backend | Triggers | As per use cases defined by the Database Engineer & |
| | | | Experience Designer triggers can server as either thresholds, |
| | | | timeboxes, automation through relativity, experience |
| | | | anchors, |
| Authority | 2-D display, 3D Backend | Access & | As defined by the Database Engineer, and Owner of the |
| | | Experience | License for the instance to determine levels of access and |
| | | Management | functions enabled at each level as it relates to experience |
| | | | management, also serves as the identify manager and |
| | | | corresponding taxonomy to match system role, customer |
| | | | access also can be managed at this level, as well as security |
| | | | properties that can be scaled or segmented within the |
| | | | system |

TERTIARY INTERDIMENSIONAL QUANTIFIER VALUE TABLE

| Fork Type | Function |
|---|---|
| Hard Fork | Customer activity classes are currently used at the interdimensional level modeled in our current perceptive 2-D |
| | reality. Currently our core perceptive qualities are attached to the 2-D cause and effect reality, but in reality, our |
| | reality is relative to the type of decision that is being made at the time, measured against several properties that |
| | would function as a measurement of quality, most are computed on the linear plane. An example is time. In |
| | instances where there are decisions with various dependencies and external factors, measured against how that |
| | decision translates from the 2-D reality to the 3-d reality is a computation that is One of the biggest gaps in the |
| | United States economic structure. With the additional classification of the interdimensional representation of |
| | this gap and the measurement opportunity which exist here, is the spork. With this additional classification |
| | being measured, this contextualizes the 2-D binary structure in a way that gives us an opportunity to |
| | contextualize data at a quantum dimensional level. Thus, the hard fork remains as a structural component of the |
| | evolutionary schematics necessary to measure interdimensional data. These functions at a computational level |
| | serve core system functions such as sign up, sign on, registration. These serve as computational quantifiers for |
| | system activity measured for a user. |
| | Computational 1 |
| | *Interdimensional use of binary context to gather interdimensional context regarding how user makes decisions |
| | based of defined set of features |
| Soft Fork | Customer activity classes at the interdimensional level have the necessity of classifying user activity data |
| | gathered by the system to measure this activity against the system definition. This can be seen as our perception |
| | of 0, as it relates how the system was structured and for whom it was built. The system has a dependency of |
| | collecting data about how customers engage with its predefined hard forks to retroactively update these |
| | functions at a core level. |
| | When 3-D activity is gathered, and computed through a 2-D context, then applied back to the 3-D space, the |
| | activity context is lost in the computation. This the inception of the “black boxes” that prevent the feedback |
| | loop across several industries. With the additional classification of the interdimensional representation of this |
| | gap and the measurement opportunity which exist here, is the spork. With this additional classification being |
| | measured, this contextualizes the 2-D binary structure in a way that gives us an opportunity to contextualize |
| | data at a quantum dimensional level.Thus, the soft fork remains as a structural component of the evolutionary |
| | schematics necessary to measure interdimensional data. The soft fork is the core of system functionality |
| | definment. |
| | Computational 0 |
| | *Interdimensional use of binary context to gather interdimensional context regarding how users engages with |
| | core system and site functions |
| Spork | System path to an absolute of function relative to the point between a hard & soft fork. Decision tree is |
| (interdimensional) | measured against the position of the conversion point to determine how to assist a customer with completing an |
| | activity. Examples of how this manifests for users are modals at end points of conversions to collect information |
| | on how to help users best with completing the funnel. |
| | The spork function as it relates to computational data architectures allows the system to reset/baseline data sets |
| | and algorithms to help users in specific user journeys. Core computation within a system collects customer |
| | activity through traditional binary structures, and leverages the spork function to quantize data to the absolute 0 |
| | baseline, which allows your data feed, structural composition of data architecture and insights aggregation |
| | tables to be informed by customer activity based upon the user journey. |
| | At a dimensional level, the spork function is representative of the information exchange through relativity of |
| | properties between datasets and between each dimension. As it relates to innovation through the scope of a 9 |
| | dimensional development path, this interdimensional space is an ongoing, interactive engagement, between a |
| | customer and the system. The context of innovation within each dimension and more specifically at the |
| | interdimensional level (where the most insight is gained from customer activity) is an eternally building and |
| | evolving space. The management of absolutes within the core computational model theory, would impact the |
| | data computation, intake, aggregation, storage of data. |
| | Computational \|0\| |
| | New Computational Function* |
| | New Blockchain Node function* |

### BIOLOGIC COMPUTATIONAL FUNCTIONS USED TO OBSERVE VARIOUS TYPES OF DATA & CORRELATING PROPERTIES

| Observational Function | Classes of Observational |
|---|---|
| in Biology | Measurement Data |
| Physiology | Customer Activity Measurement |
| Botany | Growth |
| Conservation | Support |
| Ecologic | Enterprise |
| Evolution | Enterprise Measurement |
| Zoologic | B2C, B2B, Government |
| Genetics | Operations |
| Marine Biology | Earned Value Metrics |
| Microbiology | Segmentation |
| Molecular | Personalization |

### INNOVATION PATH BASED ON DIMENSIONS AND APPLIED PROPERTIES OF MEASUREMENTS

### DETAILED DESCRIPTION OF INTENTION

(0) Dimension: is the computational function which serves as a display of content assets, data elements or linear communications on a web platform. The physics equivalent to the display classification is energy. This perspective is limited to the scope of the view of the user in Dimension 1, the back-end system function operates in Dimension 2, which is energy equivalent is measurement, and the Inter-Dimension of Dimensions 1 and 2 is the location in which applied theory of relativity lives and replaces human-like quantification methods of the properties gathered in Dimension 2. Thus creating a successful transaction-based or flat plane feedback loop in which the sku of the products or services used times or divided by the cost (if service cost is variable to usage), gives you the satisfactory level of information to produce on in a web experience to inform a user while making a decision. This specific use case as it relates to transaction measurement, application of data insights measured, conversion vs customer drop-off is executed adequately.

(1st) Dimension: is the linear computational function which serves a display of content based off of system logic tied to basic user functions like: sorting, ranking, and basic mathematical computational. This Dimension offers various lenses to view the activity measured over an elapsed time, product list and product price comparison features, etc. The quantum equivalent of this classification is position. Position is quantified based on leveraging one data element at a time to produce a predetermined result, subsequently influencing additional customer activity. This can function as a measurement only in the context of predefined functions similar to the multidimensional relation such as 3rd Dimensional next best actions or personalized user journeys by which customer activity data is gathered, formalized, evaluated, and applied in a predefined manner. This can relate to various forms of linear measurement of the transaction line within a lifecycle customer measurement cycle and the success of the application of data is relatively high across the industry as it relates to 3rd Dimensional computational experiences, but still subject to customer engagement measurement to determine how best to serve a specific 3rd Dimensional experience by application of insights. Examples of a position based computational model, is mapquest, a website in which you submit two data points and the system computes that's information against the back-end data set relative to the customer and the search, thus returning information that details the relationship between two data points outline, this class is also executed adequately.

(2nd) Dimension: is the binary computational classification which serves as a measurement of sequences as it relates to user activity, reference data, and other binary dimensional data. This can be quantified as a retroactive application of data insights, in which the application has a fixed starting point, ending point and variables that determine the computational result of that endpoint are also pre-defined, which results in a measurement subject to a fixed computational ceiling. Thus, user activity can only be measured at this scope, which limits the amount of characteristics and properties that can be defined and properly classified against this measurement. The success of the application of this type of data is relatively high based upon the quality of definition of the measurement properties leveraged, binary dimensional system logic, and repository classification structures. This can be quantified as the Dimensional class that makes metrics collections possible. This the current endpoint of market ready innovation, because as properties of the matter changes, thus changes the elements which comprises it, thus changes the relationships made in the data that tie functions and business logic to variable fields of data.

(3rd) Dimension: is the pre-quantum computational classification which enables functions such as next best action, and pre-defined segmentation based activities. The physics equivalent of this is kinetic energy, thus once a predefined path has been determined, relational properties of the energy along that path have the opportunity to combine properties through pre-defined relationships to produce a three dimensional result confined to binary dimensional properties. This creates the variance that appears in artificial intelligence and the inaccuracies at the computational basis today of machine learning.

Due to the data properties computed in the 3rd Dimension, they are classified at the Binary Dimensional level, thus data scientists have had problems identifying the way to reverse engineer an algorithmic computations for large data sets once it has gone through a system. The result of this exercise was that algorithms would out-think humans one day, which is not only false but computationally and physically impossible.

Our biggest variance between the ability to adequately enable quantum computational systems that compute measurable results, is the structure of the data, the associated classifications and how these classifications are applied. This can be quantified as computations such as satellite approximation and which is not an absolute measurement of distance and time, because universal properties can not be measured in a fixed way, as they are all in a state of constant definition.

(4th) Dimension+Beyond: is the computational function which serves experiences based upon relativity in contrast to predefined database relationships as described in the Dimension 2. The physics equivalent of this classification is potential. Potential energy can be gained by the proper classification of the data as it relates to the schema that aggregates customer activities, and it must mutate in schematics based off of activities in which it collects and the properties thereof. Because we have not yet reached proper classification of data before Congruent Quantum Computation the properties of the 4th Dimensional class are dependent on a refinement in data classifications. This relates to the core data architecture which must evolve based upon an aggregation of classifications, and dimensional relation of the data.

The contextual basis of measurement within a relational dimension is also relative to how many properties can be quantified, collected and formalized. The vortex that the relational dimensional data, and the measurement of the contextual quantification of the data and its variable context, must then be quantized against four quantum quadrants defined as: customer activity, operational activities, measurement of variances and the measurement of relativity. The structural basis for why the 4th dimension is yet to be classified, is greatly because it depends on the ability to overlap quantum theory used to launch rockets with Congruent Quantum Computational theory to determine how to build a data architecture that evolves based on measurement of activities in an environment that has yet to be quantified, thus creating the opportunity for an approximate 33% infrastructural lag with as it relates to reuse and application of data in the fourth dimension, 10%>if the activities measured are measured in a linear and binary dimensional industries. Example of this linear and binary in this instance, linear would relate to vending machines, and binary would be medical services with an operational process congruence and data classifications made in a congruent way which classifies data relative to its dimensional representation to determine computation weight of data structure before automation.

This is the current technology gap that exists within data sets across all industries that are leveraging automation based tools. Thus making the product industry brands that leverage similar technical functions have a success measurement of less than 20% and a contextual accuracy of less than 10%, based on the speed in which influence is mobilized to transact brand. The interdependence for the product industry is relative to various elements of sociocultural contributions, brand identity and the overall product life cycle, thus making its exposure to be the measurement of the probability of market conversion. Hence, present day advertising value is dependent on a fixed schedule, which is affixed to the volume of influence in the market, times the amount of time a brand needs market exposure, thus creating the ads spend value.

This process gap has been a compounding deficit year over year since 2008, and now is at upwards of $8 billion dollar deficit, through 2024 in advertising spend. The success of these programs are to be measured at an approximate 20% conversion rate, after a 30% profit margin standard to business practices taught in the United States, approx 50% of all ad revenue spends inflation suppressed in the measurement of success that is affixed to the campaign that has been launched. This inflates the projected market value of digital advertising tools and companies, cost brokers fees, and campaign life cycle cost.

Additionally, this conflates the notion that present day artificial intelligence and machine learning is currently functioning in a quantum realm, when this again is functionally and physically impossible. To define the next step in innovation is to determine the level set data structure, share information, formalize against feature necessities of the public and then determine what is the best solution based on our contextualized data set. This is necessary to determine proper measurement of innovation and quantification of the subsequent dimensional activities.

A data computation method for contextualizing data based on multiple specified parameters within an equation. In which a dataset is encoded by and classified in its micro algorithmic computation to contextualize the weight of the data element and understand how much it should influence the macro-algorithmic computation. As a result of this equation, the data will identify the maximum computing capacity for a specified result; thus, calibrating the computer science theory to the north of infinite, as this invention disproves the theory of computational absolutes.

Congruent quantum modeling is the method of structuring data in a way in which two or more classification(s) and/or sub-classifications (as defined by the dimensional categories in Invention 1.1) are organized by data structure then weighted against its computational properties, to produce an absolute 0 for the specified value and then computing the dataset after dimensional context. The property classes and the associated forms of computation below must be leveraged in the algorithmic expression to contextualize the database before computing.
Temperature—Threshold measurement is a nonlinear data class that consists of a score derived from incremental digits which computes various properties to comprise the weighted score represented by the class. An example of why the data elements within this class differ from the other classes can be observed in the boiling point for water. How this appears is constructed by the classifications in which properties can be observed in the following ways: constant, pressure of vapor, heat of vapor, pressure of heat the measurement of the correlates a temperature, thus these granular level data elements are relevant to the computation method being applied. Within a given data set, micro dependencies within the computation impact how data is reflected and creates the variance we see when it is applied. Thus the omission of granularity associated with each data element and the associated results of algorithmic functions must be weighted and precomputed within reference tables before computing the algorithm to retrieve results.
Quantity—Linear numeric function, is currently a 1 to 1 relationship with the binary computing space, but this also serves as a baseline to provide context to relativity of the insight because it has the most constant independent measurement, and other times it may be used as a reference to add value. For example, this is based on the data dimension score of the weight of the classification, and as this data dimension increases in volume as it increases in mass, therefore making the data set only as quantifiable as the last data dynamic that was computed and so forth. Current structure of this data model and practice reflects a one-dimensional transaction model that can be computed linearly with no reflective depth to gain multidimensional insight.
Percentage—impact measurement currently is a nonlinear data class that consist of a score that is derived from several data points in which insights are reflective of a specified activity tracked over a specified period of time, for example as it relates to customer behavior, measurements absolute 0, where no activity exist, but as the volume of activity over time, divided by the number of variables measured, inactivity may have an representation of 0 change, but still will not be a reflection of absolute 0. With the omission of the velocity associated with the activity score of the percentage, the data is formalized in a way that cannot processed and produced the depth of activity associated with gathering a percentage, thus making this categorically linear to the system in which it will be computed, this category will also leverage a displacement operator which will create an absolute value in which the system can be reset, before reaching the congruent state
Math—Algebraic measurement usually performed at the computation level, currently computation functions at the linear operation level, thus limiting the results of computations to 4 major categories: position, momentum, energy and angular momentum Quantum Data Computing and Structuring requires that all categorically structured data to outline the composite of the integer(s) and their activity over the course of measurement (time), should be congruent to that of the measurement at the computational level. For the purpose of computing at the quantum level all algorithms must function as an compounded and delimited algebraic algorithm for the purpose of computing data at the correct calibration; thus making it possible to compute the composite of the following types of equations by a system, software or machine:
   Polynomial systems of equation
   Univariate and multivariate polynomial evaluations
   Interpolation
   Factorization
   Decompositions
   Rational Interpolation
   Computing Matrix Factorization and decomposition (which will produce various triangular and orthogonal factorizations such as LU, PLU, QR,QPR, QLP, CS, LR, Cholesky factorizations and eigenvalue and singular value decompositions)
   Computations of the matrix characteristics and minimal polynomials
   Determinants
   Smith and Frobenius normal forms
   Ranks and Generalized Inverses
   Univariate and Multivariate polynomial resultants
   Newton's Polytopes
   Greatest Common Divisors
   Least Common Multiples
Pressure—Energy measurement is a non linear data element, that can be defined as the amount of force exerted in a defined space, thus limiting the results of the scope of the computation, and pressure computed linearly in not relative based on the space and force applied in the specific space over time, because there are various types of pressures there is a necessity to use a displacement operator which will create an absolute value in which the system can be reset, before reaching the congruent state.

1. A data computation method which leverages the properties of biology and physics to create a congruent quantum data structure by leveraging dimensional classifications, interdimensional relationships and the computations there of at the molecular level; and
the properties and observational computations to define properties of dimensions, and functions of atoms.

2. A data computation method which leverages energy principles of astrophysics to categorize data based on its dimensional representation as defined by the energy observed by the data element within a specified dimension.

3. A data computation process which leverages an integer-based computational encoder to determine absolute data value by the energy observed in the host dimension.

4. A data computation method which levages biologic functions to correlate customer activity data across various data sets to define customer segments through relativity by fission or fusion properties.

5. A data computation process which leverages physics and biologic functions to create data relativity segments at the molecular level to form activity-based audiences which are leveraged to power data-driven personalization instances online.

6. A data computation process which leverages physics energy classifications to define contextual uses of data as either measurement of previously collected activity data or measurement of the potential to collect future activities.

7. A data computation method which leverages the concept of physics and biology to define relativity at the interdimensional level and serve as a pre-computation for the subsequent dimensional data application.

8. A data computation method which leverages the core functions of linear and binary computation theory to serve as the basis for the tertiary computational model, which uses a sequence of numeric integers 1's, 0's and a new value and numeric function of |0| in computing to increase quantum computational power, formalize data structures and reverse engineer computations performed by artificial intelligence and machine learning.

9. A data computation method that leverages integer based numeric classifications and various algorithmic expressions to structure and calibrate data architectures congruent to the computational power of a modern quantum computing device.

10. A data computation method in which data can be stored in a live activity-based data schema and reference various tables holding algorithmic micro-computations based on its correlated dimension and classification as defined within an identified dataset.

11. A data computation method that utilizes various tables holding micro-computations which classify data by its energy properties and correlated algorithmic computation to determine the integer weight against the data data set to be computed in personalization experiences.

12. A data computation method that utilizes the “Y=MX+B” formula to compute the absolute |0| of a data element, define interdimensional relativities, and identify relevant dimensional computational properties.

13. A data computation method that structures quantum data and transfers it congruently through blockchain nodes for the purpose of powering multi-dimensional virtual experiences.

14. A data computation method which utilizes the functional properties associated with observational subclasses within biology to correlate various industries & customer datasets to their observational algorithmic computation.

15. A data computation method which utilizes the dimensions observed in physics to build a database architecture to collect, analyze, and compute potential energy.

16. A data computation method which combines properties of physics, biology and computational sciences to create an absolute result for previously collected kinetic energies.

17. A data computation method which combines properties and functions of physics, biology and computational sciences to identify socioeconomic and systemic biases coded into existing data architectures across various product and services based industries.

18. A data computation method which combines properties and functions of physics, biology and computational science to determine qualitative computation accuracy in statistics, actuarial sciences and global derivative markets.

19. A data computation method which combines properties and functions of physics, biology and computational science to determine quantitative computational inaccuracies in medical, social, disability support services.

20. A data computational method which combines properties and functions of physics, biology and computational sciences to determine an organization's compliance with GDPR as defined by the European Union and European Economic Area.

21. A data computation method which combines properties and functions of physics, biology and computational sciences to power the existing blockchain node computation at quantum speed for the purpose of enabling various interdimensional and multidimensional digital experiences.

22. A data computation method which combines properties and functions of physics, biology and computational science to power various multidimensional and interdimensional experiences for guided and assistive technologies.

23. A data computation method which combines properties and functions of physics, biology and computational science to recalibrate all socio economic infrastructural gaps in data or identify by data relative to industrialism, globalization and early digital ages alike.

24. A data computation method which combines properties and functions of physics, biology and computational science to increase accuracy of measurement data in clinical trials and medical research.

25. A data computation method which combines properties and functions of physics, biology and computational science to increase accuracy of aerodynamics computational sciences, satellite computational measurement in global positioning systems.

26. A data computation method which combines properties and functions of physics, biology and computational science to decrease audio wave processing time and volume of errors in lossless audio transmission.

27. A data computation method which combines properties and functions of physics, biology and computational science to proactively predict the impacts of social inequalities and society infrastructural gaps.

28. A data computation method which combines properties and functions of physics, biology and computational science to serve as core recalibration of astrophysical sciences utilized in spatial deployments of rocket ships.

29. A data computation method which combines properties and functions of physics, biology and computational science to serve as the core recalibration data processing as observed in telecommunication to deliver higher quality audio transmissions with less phone service gaps.

30. A data computation method which combines properties and functions of physics, biology and computational sciences to serve as the core recalibration for car speedometers to deliver more accuracy with speed as relative to the environment energy is dispersed.

31. A data computation method which combines properties and functions of physics, biology and computation sciences to serve as the core recalibration hydraulic mechanic function leveraged in roller coasters to deliver a safer ride experience.

32. A data computation method which combines properties and functions of physics, biology and computational science to serve as the core computation for predictive analysis utilized in all data driven experiences.

33. A data computation method which combines properties and functions of physics, biology and computational science to serve as a measurement of actual diversity statistics within organization structures.

34. A data computation method which combines properties and functions of physics, biology and computational science which serve as the calibration for 1st and 2nd dimensional datasets to be applied accurately in the 3rd dimension in a regulatory compliant way.

35. A data computation method which combines properties and functions of physics, biology and computational science which serves as the calibration for the rise over run computation as observed in architectural sciences.

36. A data computation method which combines properties and functions of physics, biology and computational science as core computational recalibration of algorithms observed in cyber security.

37. A data computation method which combines properties and functions of physics, biology and computational science as core computational recalibration of measurement of data measurement, storage and usage observed in service industries.
